(19) United States
(12) Patent Application Publication
(10) Pub. No.: US 2025/0046050 A1
(43) Pub. Date: Feb. 6, 2025

(54) INFORMATION PROCESSING APPARATUS, METHOD OF CONTROLLING INFORMATION PROCESSING APPARATUS, AND MEDIUM

(71) Applicant: CANON KABUSHIKI KAISHA, Tokyo (JP)

(72) Inventor: Akihiro HORI, Tokyo (JP)

(21) Appl. No.: 18/785,285

(22) Filed: Jul. 26, 2024

(30) Foreign Application Priority Data
Aug. 3, 2023 (JP) 2023-127327

(51) Int. Cl. G06V 10/25; G06F 3/14; G06T 5/50; G06T 7/11

(52) U.S. Cl. CPC G06V 10/25; G06F 3/14; G06T 5/50; G06T 7/11; G06T 2207/20221

(57) ABSTRACT

An information processing apparatus obtains a captured image including a structure to be inspected; obtains in-focus degree information indicating a degree of in-focus of each of a plurality of regions of the captured image; selects one or more partial regions from a plurality of partial regions obtained by dividing the captured image into regions; and determines whether the captured image satisfies an in-focus condition necessary for being used in inspection. In the determination, the apparatus identifies, as an in-focus region, a region that is in focus in a first region, and determines whether the captured image satisfies the in-focus condition based on a ratio of a surface area of the first region to a surface area of the in-focus region.

### BACKGROUND OF THE INVENTION

### Field of the Invention

The present disclosure relates to a technique for determining the quality of a captured image.

### Description of the Related Art

Conventionally, inspection for defects in infrastructure such as bridges and tunnels has been performed by a worker directly viewing the infrastructure or using instruments, but in recent years, inspection in which images in which infrastructure is captured are used has been performed. In inspection (image inspection) in which captured images are used, in order to detect defects such as cracks, the captured images need to satisfy a predetermined image quality. Japanese Patent Laid-Open No. 2022-75510 (Patent Literature 1) discloses a technique for determining whether a captured image satisfies a predetermined image quality based on a degree of in-focus, a frequency analysis result, and an image capturing resolution and identifying whether the image needs to be recaptured according to a determination result.

However, according to Patent Literature 1, there are cases where when infrastructure to be inspected is included in a captured image, even if the region of the infrastructure to be inspected satisfies the predetermined image quality, it is determined that image recapturing is necessary.

### SUMMARY OF THE INVENTION

According to one aspect of the present invention, an information processing apparatus comprises: an image obtaining unit configured to obtain a captured image including a structure to be inspected; an information obtaining unit configured to obtain in-focus degree information indicating a degree of in-focus of each of a plurality of regions of the captured image; a selection unit configured to select one or more partial regions from a plurality of partial regions obtained by dividing the captured image into regions; and a determination unit configured to determine whether the captured image satisfies an in-focus condition necessary for being used in inspection, wherein the determination unit identifies, as an in-focus region, a region that is in focus in a first region, in which an accuracy of determination in which the in-focus degree information is used is greater than or equal to what is predetermined, in the selected one or more partial regions, and determines whether the captured image satisfies the in-focus condition necessary for being used in inspection based on a ratio of a surface area of the first region to a surface area of the in-focus region.

According to another aspect of the present invention, an information processing apparatus comprises: an image obtaining unit configured to obtain a captured image including a structure to be inspected; an information obtaining unit configured to obtain frequency information indicating a result of analyzing a frequency of the captured image; a selection unit configured to select one or more partial regions from a plurality of partial regions obtained by dividing the captured image into regions; and a determination unit configured to determine whether the captured image satisfies an in-focus condition necessary for being used in inspection based on the frequency information and the selected one or more partial regions.

The present disclosure makes it possible to more appropriately determine the image quality of a captured image.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram illustrating a hardware configuration of an image capturing system and each apparatus.

FIG. 2 is a diagram illustrating a functional configuration of an information processing apparatus.

FIG. 3 is a flowchart illustrating the operation of the information processing apparatus.

FIGS. 4A and 4B are diagrams illustrating examples of a determination region.

FIG. 5 is a detailed flowchart of image quality determination processing (step S306) (first embodiment).

FIGS. 6A and 6B are diagrams illustrating examples of a defocus map.

FIG. 7 is a diagram illustrating a display example of an image quality determination result (first embodiment).

FIG. 8 is a flowchart of image quality determination processing (step S306) (second embodiment).

FIG. 9 is a diagram illustrating a display example of an image quality determination result (second embodiment).

FIGS. 10A and 10B are a flowchart of image quality determination processing with retries.

FIG. 11 is a flowchart of image quality determination processing (step S306) (third embodiment).

FIG. 12 is a diagram illustrating an example of a UI screen for setting a determination condition.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate.

Furthermore, in the attached drawings, the same reference numerals are given to the same or similar configurations, and redundant description thereof is omitted.

### First Embodiment

A first embodiment of an information processing apparatus according to the present disclosure will be described below using an information processing apparatus for obtaining a captured image of a structure by controlling an image capturing apparatus as an example.

### <System Configuration and Apparatus Configuration>

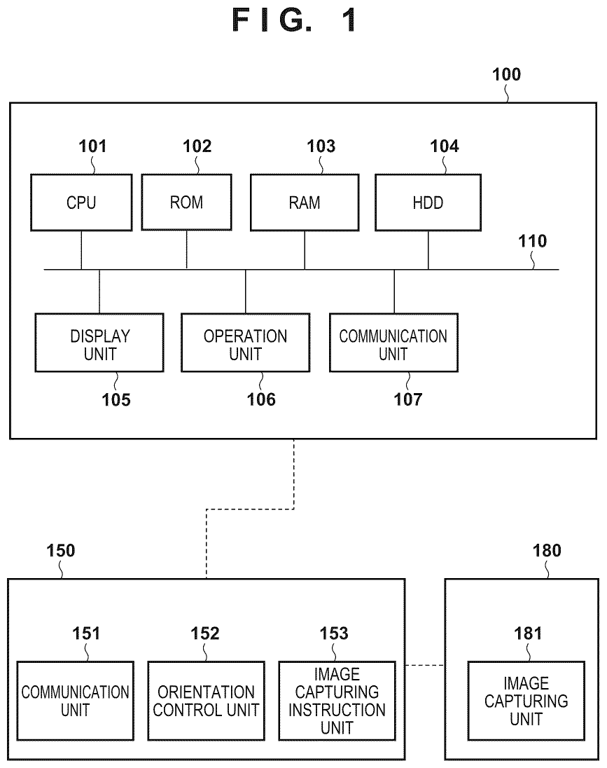

FIG. 1 is a diagram illustrating a configuration of an image capturing system and a hardware configuration of each apparatus. The image capturing system is a system for performing inspection (image inspection) of a structure based on an image in which the structure is captured. Examples of a structure include a bridge, a tunnel, a road, a building, a dam, an embankment, electrical equipment, and the like. The image capturing system is configured to include an information processing apparatus 100, an image capturing assistance apparatus 150, and an image capturing apparatus 180, which are connected so as to be capable of communication.

The information processing apparatus 100 is an apparatus for controlling the entirety of image capturing processing of the image capturing system. The information processing apparatus 100 includes a central processing unit (CPU) 101, a read-only memory (ROM) 102, a random access memory (RAM) 103, and a hard disk drive (HDD) 104. The information processing apparatus 100 further includes a display unit 105, an operation unit 106, and a communication unit 107.

The CPU 101 performs computation, logical determination, and the like for various kinds of processing by executing a program and thus controls each component connected to a system bus 110. The ROM 102 is a program memory and stores programs for control by the CPU 101, which includes various processing procedures to be described later. The RAM 103 is used as a temporary storage region such as a main memory and a work area of the CPU 101. The program memory may be realized by loading a program into the RAM 103 from an external storage apparatus or the like connected to the information processing apparatus 100.

The HDD 104 is a storage apparatus for storing electronic data, such as image data according to the present embodiment, and programs. An external storage apparatus may be used to serve a similar role. Here, the external storage apparatus can be realized by, for example, a medium (storage medium) and an external storage drive for realizing access to the medium. As such a medium, for example, a flexible disk (FD), a CD-ROM, a DVD, a USB memory, an MO disk, a flash memory, and the like are known. The external storage apparatus may be a server apparatus or the like connected by a network.

The display unit 105 is, for example, a liquid crystal display (LCD), an organic EL display (OLED), or the like and is a device for outputting an image to a display screen. The display unit 105 may be an external apparatus connected to the information processing apparatus 100 by wire or wirelessly. The operation unit 106 is a device such as a keyboard and a mouse and accepts various operations by a user.

The communication unit 107 performs bidirectional communication with another information processing apparatus, communication apparatus, external storage apparatus, and the like by wire or wirelessly according to a known communication technology. The communication unit 107 may be configured by, for example, a chip or an antenna for performing wireless communication and performs communication by a wireless communication method such as a public wireless network (e.g., 4G or 5G), a wireless LAN, or Bluetooth®.

The image capturing assistance apparatus 150 is a head apparatus capable of changing an image capturing position and an image capturing direction based on control from the information processing apparatus 100. The image capturing apparatus 180 to be described later is mounted on the image capturing assistance apparatus 150. The image capturing assistance apparatus 150 includes a communication unit 151, an orientation control unit 152, and an image capturing instruction unit 153.

The communication unit 151 communicates with the information processing apparatus 100 by wire or wirelessly and performs control of a position and an orientation (image capturing direction and position) and image capturing instruction according to instructions from the information processing apparatus.

The communication unit 151 may be configured by, for example, a chip or an antenna for performing wireless communication and performs communication by a wireless communication method such as a public wireless network (e.g., 4G or 5G), a wireless LAN, or Bluetooth®.

The orientation control unit 152 changes the orientation (image capturing direction and position) of the head apparatus such that an image capturing region of a designated inspection target subject can be imaged. The image capturing instruction unit 153 controls the image capturing apparatus 180, which has been set in the image capturing direction and position changed by the orientation control unit 152, so as to perform image capturing.

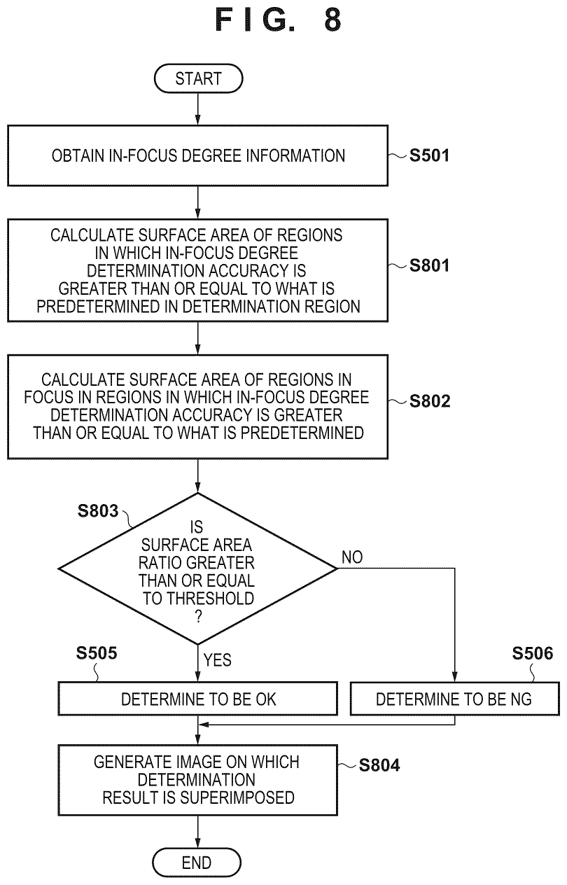

The image capturing apparatus 180 is an apparatus that performs image capturing based on image capturing instruction information received from the information processing apparatus 100 via the image capturing assistance apparatus 150. For example, the image capturing apparatus 180 includes an image capturing unit 181 including an image capturing optical system and an image capturing element. The image capturing element includes, for example, a full image plane phase difference image capturing sensor and records in-focus degree information (defocus value) at each pixel position in the captured image. The in-focus degree information will be described later in detail with reference to FIG. 8. Here, the in-focus degree information is data representing a spatial (two-dimensional) distribution of defocus values in an image capturing range. In the following description, data representing a spatial distribution of defocus values is also referred to as a defocus map. A defocus value is an amount of shift in focus from a distance at which an optical system of the image capturing apparatus 180 is focused. That is, the defocus map indicates a defocus value for each pixel of an image as a spatial distribution.

Each pixel of the full image plane phase difference image capturing sensor of the image capturing apparatus 180 includes two photoelectric conversion units, and these are assumed to be subpixel A and subpixel B. In the full image plane phase difference image capturing sensor, it is assumed that subpixels A and B, which are regularly arranged on a two-dimensional plane, output an image A and an image B, respectively, as parallax images. In addition, an A+B image obtained by adding the image A and the image B are recorded as a recorded still image. Defocus values are calculated based on a phase difference between these parallax images. Here, description will be given using a configuration in which defocus values are derived in pixel units as an example, but defocus values may be derived for each predetermined region such as block units including a plurality of pixels (e.g., 5 pixels×5 pixels).

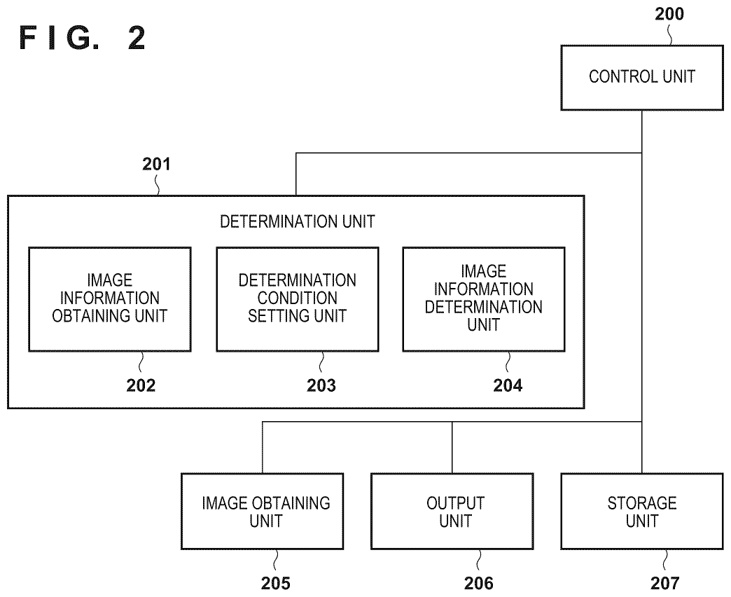

FIG. 2 is a diagram illustrating a functional configuration of the information processing apparatus 100. The information processing apparatus is an apparatus for implementing an information processing method of determining the quality of a captured image and the necessity of recapturing that image. The information processing apparatus 100 includes a control unit 200, a determination unit 201, an image obtaining unit 205, an output unit 206, and a storage unit 207. Each of these functional units is realized by the CPU 101 deploying, in the RAM 103, a program stored in the ROM 102 and executing the program. However, some or all of these functional units may be configured to be realized by hardware.

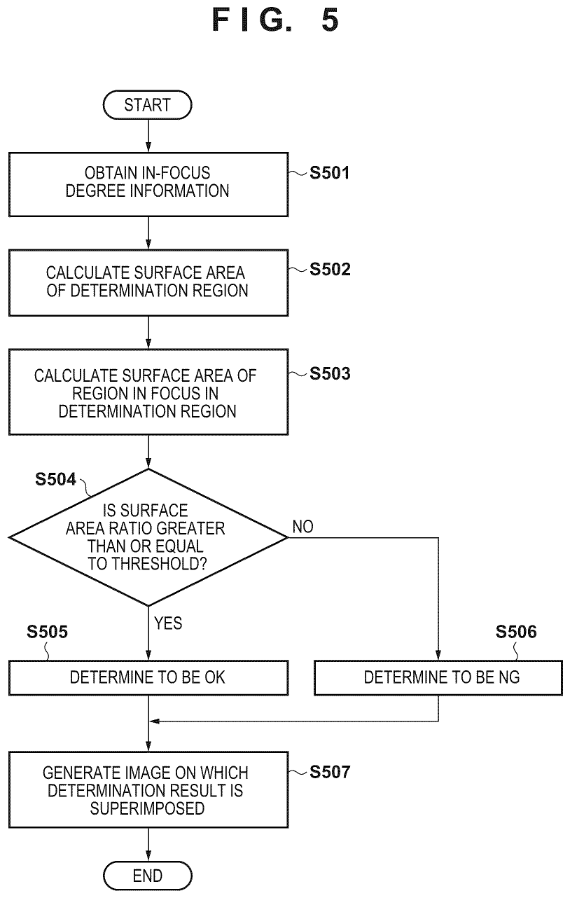

The control unit 200 controls execution of various kinds of processing by each functional unit. The determination unit 201 is a functional unit that determines whether an image satisfies a predetermined image quality. The determination unit 201 includes an image information obtaining unit 202, a determination condition setting unit 203, and an image information determination unit 204. The image information obtaining unit 202 analyzes an image and obtains a degree of in-focus, frequency information, and the like in the image. The determination condition setting unit 203 sets a determination condition to be described later with reference to FIG. 5. The image information determination unit 204 determines an image quality based on the determination condition set by the determination condition setting unit 203 based on the image information obtained by the image information obtaining unit 202. The image obtaining unit 205 obtains a captured image obtained by image capturing by the image capturing apparatus 180. The output unit 206 outputs the captured image and a result determined by the determination unit 201. The storage unit 207 holds the captured image, the determination condition set by the determination condition setting unit 203, and the determination result obtained by the image information determination unit 204.

### <Operation of Apparatus>

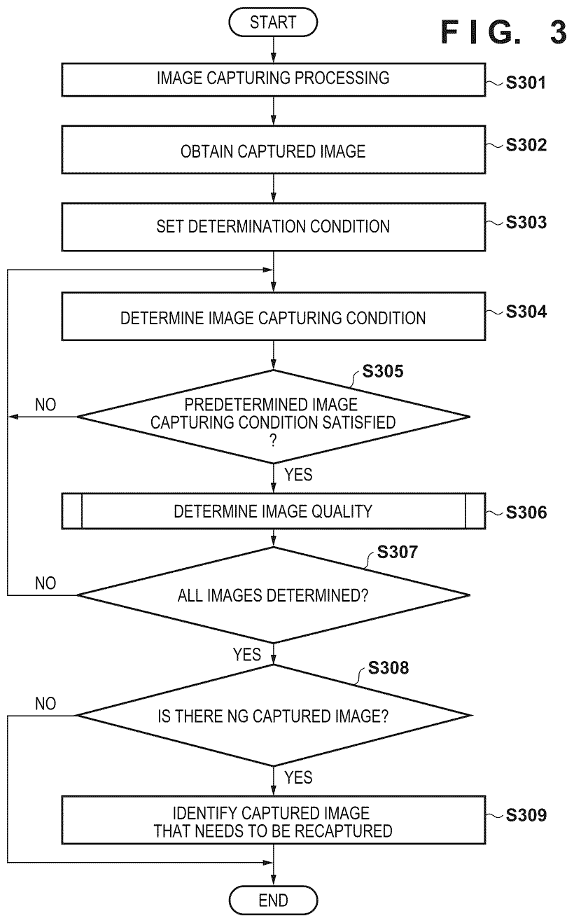

FIG. 3 is a flowchart illustrating the operation of the information processing apparatus 100. The flowchart is started by the information processing apparatus 100 executing a program.

In step S301, the control unit 200 performs image capturing processing. The image capturing processing is processing in which image capturing is performed by the information processing apparatus 100 controlling the image capturing assistance apparatus 150 and the image capturing apparatus 180.

In step S302, the image obtaining unit 205 obtains a captured image. Specifically, one or more captured images to be processed in subsequent steps S304 to S306 are obtained.

In step S303, the determination condition setting unit 203 obtains a determination condition designated by the user via the operation unit 106 and stores the determination condition in the storage unit 207. The stored determination condition is used in image quality determination processing of step S306 to be described later.

In steps S304 to S306, processing for determining whether the captured image satisfies each of an image capturing condition and an image quality is performed for each of the one or more captured images obtained in step S302.

In step S304, the image information obtaining unit 202 obtains image information of an inputted image and stores the image information in the storage unit 207. Then, the image information determination unit 204 performs image capturing condition determination processing for determining image capturing condition information for when the captured image was captured based on the obtained image information.

In step S305, the image information determination unit 204 determines whether to transition to processing of step S306 for the processing target image based on a result of the determination of step S304. If it is determined that the captured image satisfies a predetermined image capturing condition (Yes), the processing proceeds to step S306, and if it is determined that the captured image does not satisfy a predetermined image capturing condition (No), determination information “NG” indicating that it cannot be used is stored in the storage unit 207 and the processing proceeds to step S304. Instead of storing the determination information “NG”, “(determination condition) not satisfied” may be stored. In the case of transitioning to step S304, an unprocessed captured image to be processed next is selected.

In the image capturing condition determination processing (step S304), if the determined image capturing condition of the captured image does not match the predetermined image capturing condition, it is determined and is stored in the storage unit 207 that the captured image currently being processed is an image that needs to be recaptured. Further, by performing the determination processing of step S304 in which the image capturing condition is used, it is possible to determine a captured image that needs to be recaptured without performing the image quality determination processing of step S306 to be described later. Further, by performing the image capturing condition determination processing of step S304, which is lower in load than the image quality determination processing of step S306 to be described later, in a preceding stage, it is possible to reduce processing time.

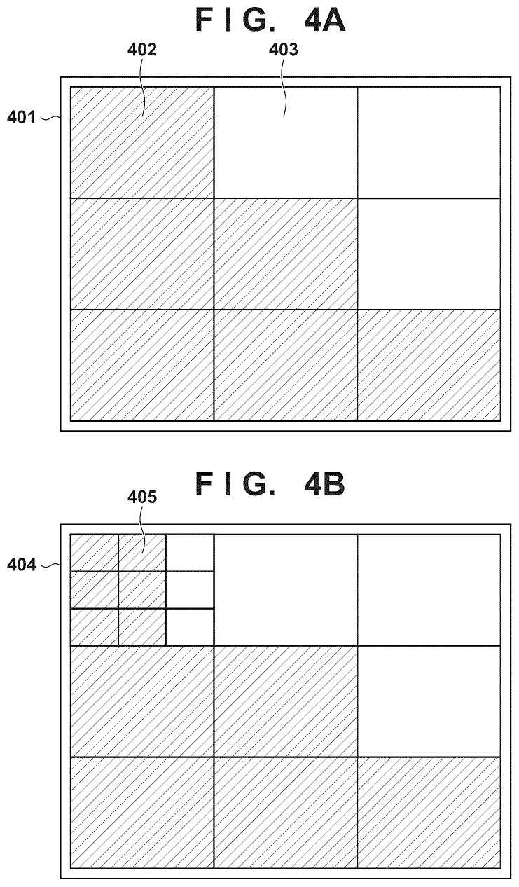

In step S306, the image information determination unit 204 implements image quality determination processing for determining the image quality of the captured image. Here, the image quality means a degree of occurrence of bokeh and blurring in the captured image (the smaller the degree of occurrence, the higher the image quality). The image quality determination processing will be described later in detail with reference to the flowchart of FIG. 5. In the image quality determination processing in step S306, the image quality is determined using the determination condition set in step S303 and using, for example, in-focus degree information indicating a degree of in-focus of the captured image, and determination information (“OK” or “NG”) is stored in the storage unit 207. The determination condition in image quality determination in which in-focus degree information is used includes, for example, an in-focus degree threshold for each determination region illustrated in FIGS. 4A and 4B.

The in-focus degree information is used, because there is a high risk that image processing necessary for inspection, such as defect detection and compositing, cannot be properly implemented for an image that is not properly focused on an inspection surface, and the image should not be used for inspection. A shift in an in-focus position may occur, for example, when a gust of wind causes the image capturing apparatus 180 to move during image capturing processing. Further, it may also occur due to an obstacle (e.g., another worker or bird) entering a ranging point of the image capturing apparatus, between the image capturing apparatus and the inspection target surface, and control for autofocusing on that obstacle being performed.

Here, an example in which, in the image quality determination processing (step S306), the image quality is determined using the in-focus degree information has been described, but determination may be made based on, for example, a resolution indicated by the number of pixels per unit length of an inspection surface.

FIGS. 4A and 4B are diagrams illustrating examples of a determination region. The determination region is, for example, a region in which infrastructure to be inspected is captured in a captured image. More specifically, it is an image region to be used at the time of inspection (image inspection) in a captured image. FIGS. 4A and 4B each illustrate an example of a determination region in the image quality determination processing of step S306. Outer frames 401 and 404 are frames corresponding to the image size of an input image (captured image). The input image is divided into a plurality of regions, and a region 402 designated by the user from among a plurality of divided regions is assumed as a determination region, and a region 403 not designated by the user is assumed as a region for which determination will not be performed. Designation from the user is accepted for the remaining seven regions in a similar manner, and as a result, a determination region (six partial regions) indicated as a hatched region and a region (three partial regions) for which determination will not be performed indicated as a white region are set.

In the example of FIG. 4A, an example in which a rectangle is assumed as the shape of each divided region has been described, but it may be another shape. For example, a configuration in which a circle or a freehand shape is assumed may be taken. Further, an example in which a determination region is selected from nine (3×3) equally-divided regions has been described, but another form may be taken. For example, a configuration may be taken so as to perform division into a different number of divisions, such as 15 (5×3) equally-divided regions or 24 (6×4) equally-divided regions. Further, as illustrated in FIG. 4B, a configuration may be taken so as to allow detailed selection of a determination region from regions 405 obtained by further finely dividing a divided region 402.

In step S307, the image information determination unit 204 determines whether the processing of steps S304 to S306 has been completed for all the captured images inputted in step S302. If the processing has been completed for all the captured images (Yes), the processing proceeds to step S308, and if processing has not been completed (No), the processing proceeds to step S304. In the case of transitioning to step S304, an unprocessed captured image to be processed next is selected.

In step S308, the image information determination unit 204 determines whether an image quality determination result “NG” is included in the determination information stored in the storage unit 207. If it is included (Yes), the processing transitions to step S309, if it is not included (No), the processing ends.

In step S309, the image information determination unit 204 identifies a captured image that needs to be re-captured and outputs information of the identified captured image via the output unit 206. In the first embodiment, the output unit 206 outputs information indicating a result of the determination in step S306 in association with a respective captured image that has been a target of determination. For example, information “OK” indicating that the image quality satisfies the condition or information “NG” indicating that the image quality does not satisfy the condition is outputted in association with a captured image. Further, a configuration may be taken so as to output, for example, information indicating that “it can/cannot be used for image processing such as defect detection and compositing” or “image recapturing is necessary/unnecessary” in association with a captured image.

Further, in the output of step S309, it need only be that a captured image for which it has been identified that image recapturing is necessary can be identified, and for example, a configuration may be taken so as to store a captured image that needs to be recaptured in a predetermined folder (e.g., “NG” folder). Further, a composite image (e.g., FIG. 7 to be described later) that indicates to a worker an image capturing position/range that needs to be recaptured may be generated based on an image capturing position/range of a respective captured image. Further, a configuration may be taken so as to output that a captured image in which the image quality does not satisfy the condition or a captured image that need to be recaptured is included as screen display or sound.

FIG. 5 is a detailed flowchart of the image quality determination processing (step S306) in the first embodiment.

In step S501, the image information determination unit 204 obtains in-focus degree information included in a processing target image. Here, the in-focus degree information is a defocus map (information in which a defocus value for each region of a captured image is recorded) which is information obtained together with an image captured by an image capturing apparatus including a full image plane phase difference image capturing sensor. Further, it is assumed that the in-focus degree information includes accuracy (in-focus degree determination accuracy) representing the reliability of a defocus value recorded for each region of the image.

In step S502, the image information determination unit 204 calculates a surface area (e.g., total number of pixels in a determination region) of a determination region (six hatched regions of FIG. 4A) designated by the user. Here, a surface area that includes a region in which the in-focus degree determination accuracy is low is calculated.

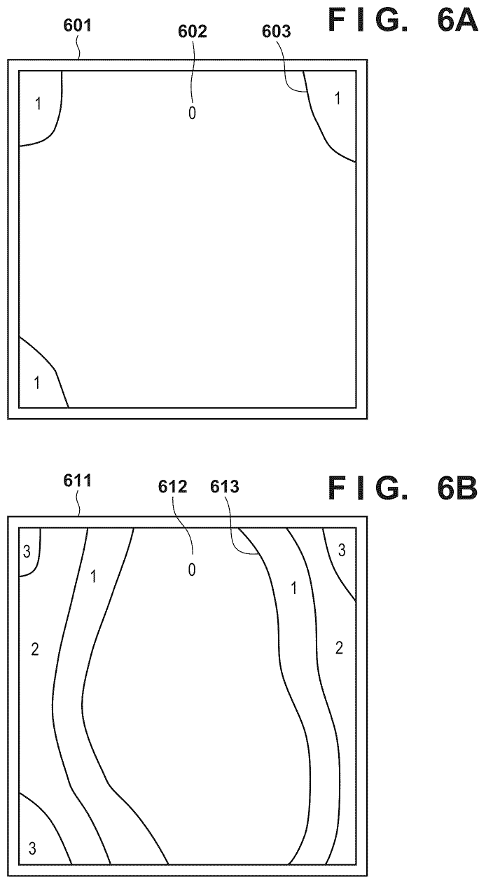

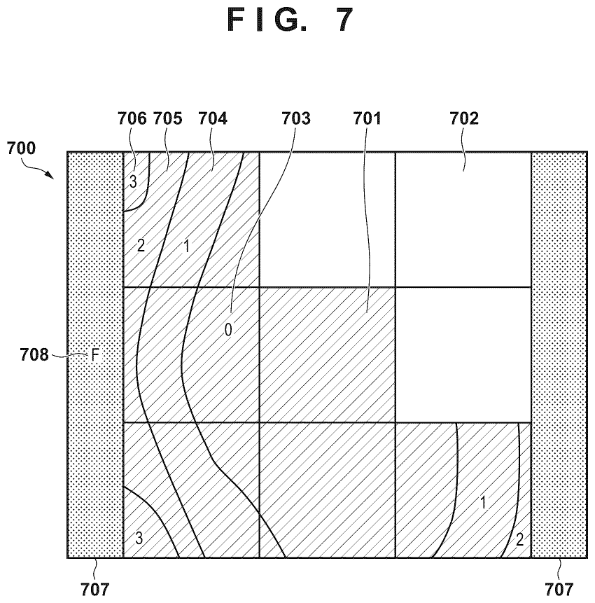

In step S503, the image information determination unit 204 calculates a “surface area of a region in focus (in-focus region)” in the determination region (regions 402) using the in-focus degree information obtained in step S501. For example, a surface area of a region in which the defocus value is less than a predetermined value is calculated. For example, in FIG. 6A or 6B, the number of pixels in which the defocus value is “0” is calculated.

FIGS. 6A and 6B are diagrams illustrating an example of defocus values, which are in-focus degree information. FIG. 6A illustrates a contour map (contour diagram) of defocus values (“0” and “1”) in two levels (1 bit), and FIG. 6B illustrates a contour map of defocus values (“0”, “1”, “2”, and “3”) in four levels (2 bits). However, the number of levels (number of bits) of defocus values is not limited thereto.

Outer frames 601 and 611 are frames corresponding to the image size of an input image (captured image). Numerical values 602 and 612 are defocus values in respective regions. Lines 603 and 613 indicate boundaries between regions in which defocus values are different. A defocus value is obtained by quantifying the amount of front and back shift in focus on an object as an absolute value. Here, it is assumed that defocus values (defocus map) are obtained from the full image plane phase difference image capturing sensor, but a configuration may be taken so as to obtain the defocus values using parallax images captured by a stereo camera or the like.

A configuration may be taken so as to, instead of representing a defocus value using an absolute value, indicate a defocus value using a positive value (shift in focus in a near-side direction) and a negative value (shift in focus in a depth direction). Further, for a region in which the accuracy of the defocus value is low, a maximum value of a defocus value that can be set may be recorded regardless of the recorded defocus value.

In the contour map of FIG. 6A or 6B, a region in which a defocus value “0” has been assigned is a region (in-focus region) in which focus is aligned in in-focus units of the image capturing apparatus 180. Further, a region (out-of-focus region) having a value greater than the defocus value “0” is a region in which focus is shifted. The greater the value of the defocus value, the greater the amount of shift in focus (the poorer the degree of in-focus).

In step S504, the image information determination unit 204 determines whether a ratio of the surface areas (number of pixels) calculated in steps S502 and S503 is greater than or equal to a predetermined threshold. For example, when described with reference to FIG. 4A and FIG. 6A, calculation is performed assuming a surface area of the determination region 402 (number of pixels) as a denominator and the number of pixels for which the defocus value is “0” in the determination region 402 as a numerator. That is, in the determination region 402, a ratio (surface area ratio) of an in-focus region is calculated. Then, if the ratio is greater than or equal to the threshold (Yes), the processing transitions to step S505, and if the ratio is less than the threshold (No), the processing transitions to step S506. For example, if the threshold is “80%”, in FIG. 6A it is determined that the determination region 402 is not less than the threshold, and in FIG. 6B it is determined to be less than the threshold. The threshold may be arbitrarily set by the user. Further, a configuration may be taken so as to decide the threshold based on a relationship between the ratio of an in-focus region and a detection accuracy of detecting a defect. For example, a ratio of an in-focus region such that the accuracy of detecting a defect is greater than or equal to 95% may be set in advance as a threshold.

In step S505, the image information determination unit 204 determines that “image quality is OK” for the processing target captured image. That is, it is determined that the captured image does not need to be recaptured because it satisfies the in-focus conditions necessary for being used in inspection. Meanwhile, in step S506, the image information determination unit 204 determines that “image quality is NG” for the processing target captured image. That is, it is determined that image recapturing is necessary. In steps S505 and S506, the determination result is recorded in the storage unit 207.

In step S507, the image information determination unit 204 generates an image on which the determination result is superimposed, using information of the determination result. Then, the output unit 206 performs display control for displaying the generated image on the display unit 105. The image to be generated will be described with reference to FIG. 7.

FIG. 7 is a diagram illustrating a display example of an image quality determination result in the first embodiment. Here, an example in which the contour map illustrated in FIG. 6B is used is illustrated. A result image 700 includes divided regions 701 (six regions indicated by hatching) to be used for determination, divided regions 702 (three regions indicated in white) not to be used for determination, and frame regions 707.

Further, in the result image 700, a region 703 in which the defocus value is “0”, a region 704 in which defocus value is “1”, a region 705 in which the defocus value is “2”, and a region 706 in which the defocus value is “3” are indicated. Here, the defocus values are displayed in a superimposed manner only on the divided regions 701 for which determination is to be performed.

Further, in a frame region 707, an in-focus degree determination icon 708 is displayed as a display representing a determination result. In the result image 700, an example in which the in-focus degree determination is OK (denoted as “F”, which means focus) is indicated. For example, a display form of “F” may be changed (e.g., black/white character) between a case where it is determined to be OK and a case where it is determined to be NG. Alternatively, the color of the icon or the color of the frame regions 707 may be changed (e.g. blue/red). This makes it possible for the user to more easily recognize the determination result.

A configuration is taken so as to obtain, in step S503, a surface area of a region in which the defocus value is “0”, but the present invention is not limited thereto. For example, a configuration may be taken so as to obtain a surface area of a region in which the defocus value is less than or equal to a threshold, such as less than or equal to 1 (i.e., “0” or “1”).

Further, a configuration may be taken so as to obtain, in step S503, a surface area of a region in which the defocus value is “3” and, if a ratio of that surface area is less than a threshold, advance the processing to step S505 and, if a ratio of that surface area exceeds a threshold, advance the processing to step S506. Further, a configuration may be taken so as to obtain, in step S503, a first surface area of a region in which the defocus value is “0” and a second surface area of a region in which the defocus value is “3”. A configuration may be taken so as to then, in this case, if a ratio of the first surface area exceeds a first threshold and a ratio of the second surface area is less than a second threshold, advance the processing to step S505 and, otherwise, advance the processing to step S506.

As described above, it is possible to determine whether an in-focus degree of an image satisfies each of two or more conditions and determine whether the image quality of the image is OK (can be used for image processing such as defect detection and compositing). Further, a configuration may be taken so as to be used to determine whether image recapturing is necessary.

In the above description, an example in which, in the image quality determination processing (step S306), a degree of in-focus in the determination region designated by the user is used has been described. However, the image quality may be determined by another method. For example, the image quality may be determined based on a predetermined threshold of an intensity of bokeh by calculating a degree of bokeh from an amount of distribution of high frequency components and low frequency components using frequency analysis processing.

That is, a configuration may be taken so as to generate bokeh information indicating a degree of bokeh in a determination region using frequency analysis processing and determine whether the image quality of an image is OK based on the bokeh information. Further, the determination may be performed by combining information indicating the degree of bokeh with information of a degree of in-focus.

As described above, according to the first embodiment, when determining the image quality of a captured image to be used for image inspection of infrastructure, the image quality is determined for a determination region considering a region in which infrastructure to be inspected is captured. This makes it possible to avoid situations in which image recapturing becomes necessary due to image quality determination being NG based on portions other than that of infrastructure to be inspected in a captured image.

### Second Embodiment

A subject that does not have contrast (e.g., monochromatic flat subjects) is considered to be a subject on which it is difficult to align focus, and infrastructure that is mainly constituted by concrete corresponds to such a subject. Therefore, there are cases where, in a captured image in which infrastructure constituted by concrete is captured, there is a region in which the accuracy of determination in which the in-focus degree information is used is low. If there is a region of low accuracy, a range in variation (variance) of defocus values of that region is broad, and so, an image quality determination result becomes unreliable.

Therefore, in the second embodiment, a form in which image quality determination is performed only in a region in which the accuracy of determination (in-focus degree determination) in which the in-focus degree information is used is greater than or equal to what is predetermined will be described. Further, a form in which in-focus degree determination is retried while changing the determination region in order to reduce the burden on the user for when the in-focus degree determination is NG will be described. Hereinafter, description will be omitted for portions that are similar to the first embodiment, and only points that are different from the first embodiment will be described.

### <Operation of Apparatus>

FIG. 8 is a flowchart of the image quality determination processing (step S306) in the second embodiment. An example of using, in the first embodiment (FIG. 5), only a region in which the accuracy of determination in which in-focus degree information is used is greater than a predetermined condition is indicated. A difference is that steps S502, S503, S504, and S507 of FIG. 5 have been replaced with steps S801, S802, S803, and S804.

In step S801, the image information determination unit 204 calculates a surface area of a region in which the in-focus degree determination accuracy is high in the determination region (six hatched regions of FIG. 4A) designated by the user. For example, the number of pixels for which an in-focus degree determination accuracy (e.g., variance) recorded for each partial region (for each pixel) is less than a predetermined value in the determination region is calculated.

In step S802, the image information determination unit 204 calculates a “surface area of an in-focus region” in a region in which the in-focus degree determination accuracy determined in step S801 is high, using the in-focus degree information obtained in step S501. For example, a surface area of a region in which the defocus value is less than a predetermined value is calculated. For example, in FIG. 6A or 6B, the number of pixels in which the defocus value is “0” is calculated.

In step S803, the image information determination unit 204 determines whether a ratio of the surface areas (number of pixels) calculated in steps S801 and S802 (surface area of step S801 is a denominator and surface area of step S802 is a numerator) is greater than or equal to a predetermined threshold. Then, if the ratio is greater than or equal to the threshold (Yes), the processing transitions to step S505, and if the ratio is less than the threshold (No), the processing transitions to step S506.

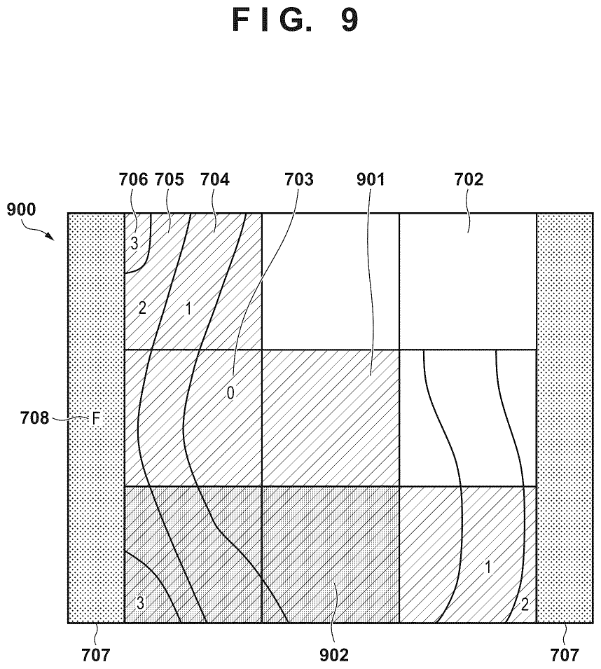

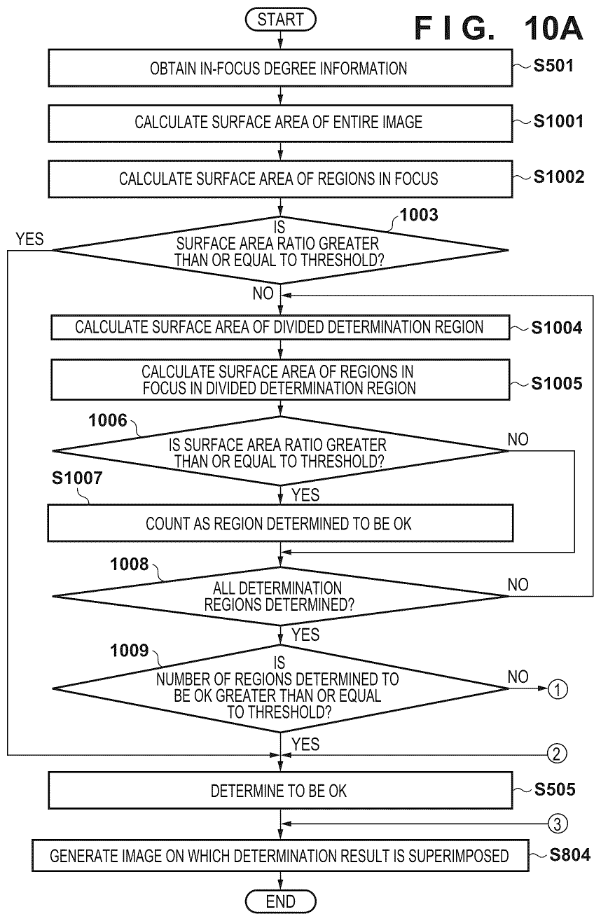

In step S804, the image information determination unit 204 generates an image on which the determination result is superimposed, using information of the determination result, and outputs the image via the output unit 206. The image to be generated will be described with reference to FIG. 9.

FIG. 9 is a diagram illustrating a display example of an image quality determination result in the second embodiment. Here, similarly to the first embodiment (FIG. 7), an example of a case where the contour map illustrated in FIG. 6B is used is illustrated. A result image 900 includes divided regions 901 (four regions indicated by hatching+a white background) used for determination and divided regions 902 (two regions indicated by hatching+a gray background) in which a surface area of the region in which, although determination in which in-focus degree information is used has been performed, the accuracy of that determination is high is less than a predetermined threshold. In addition, divided regions 702 not used for determination (three regions indicated in white) and frame regions 707 are further included. The divided regions 902 include many regions in which the in-focus degree determination accuracy is low. By the divided regions 902 being presented, the user can ascertain, as a determination result, that a check is necessary.

Further, in the result image 900, the region 703 in which the defocus value is “0”, the region 704 in which defocus value is “1”, the region 705 in which the defocus value is “2”, and the region 706 in which the defocus value is “3” are indicated. Here, the defocus values are displayed in a superimposed manner only on the divided regions 901 and 902.

Here, the divided regions 902 are represented in a form different from that of the divided regions 901 as a display indicating that a surface area of a region in which the in-focus degree determination accuracy is high is less than a threshold. However, they may be represented by thickening the frame of the region, changing the color, or the like. This makes it possible for the user to easily confirm that there is a region in which the in-focus degree determination accuracy is low in a captured image.

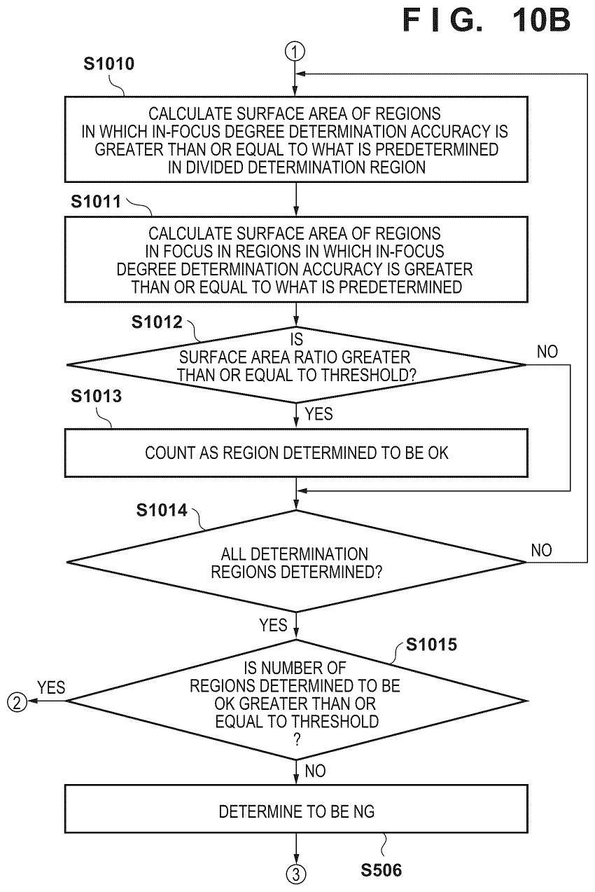

FIGS. 10A and 10B are a flowchart of image quality determination processing with retries. Specifically, in-focus degree determination is performed on the entire captured image, and if it is determined that the image quality is NG, image quality determination is performed on each partial region obtained by dividing the captured image into regions. Then, if the number of partial regions in which the image quality is OK is not greater than or equal to a predetermined number, image quality determination is performed for regions in which the in-focus degree determination accuracy is greater than or equal to a predetermined value in each partial region. Portions different from FIGS. 5 and 8 will be described below.

In step S1001, the image information determination unit 204 calculates a surface area (e.g., total number of pixels) of the entire captured image. In step S1002, the image information determination unit 204 calculates a “surface area of a region in focus” in the (entire) captured image using the in-focus degree information obtained in step S501.

In step S1003, the image information determination unit 204 determines whether a ratio of the surface areas (number of pixels) calculated in steps S1001 and S1002 (surface area of step S1001 is a denominator and surface area of step S1002 is a numerator) is greater than or equal to a predetermined threshold. Then, if the ratio is greater than or equal to the threshold (Yes), the processing transitions to step S505, and if the ratio is less than the threshold (No), the processing transitions to step S1004.

In step S1004, the image information determination unit 204 assumes one of the partial regions obtained by dividing the captured image by a predetermined number of divisions as the determination region and calculates a surface area of the determination region.

In step S1005, the image information determination unit 204 calculates a “surface area of a region in focus” in the determination region using the in-focus degree information obtained in step S501.

In step S1006, the image information determination unit 204 determines whether a ratio of the surface areas (number of pixels) calculated in steps S1004 and S1005 (surface area of step S1004 is a denominator and surface area of step S1005 is a numerator) is greater than or equal to a predetermined threshold. Then, if the ratio is greater than or equal to the threshold (Yes), the processing transitions to step S1007, and if the ratio is less than the threshold (No), the processing transitions to step S1008.

In step S1007, the image information determination unit 204 counts the number of regions in which it is determined in step S1006 that the ratio is greater than or equal to the predetermined threshold (Yes) and records the number in the storage unit 207.

In step S1008, the image information determination unit 204 determines whether the processing of steps S1004 to S1006 has been completed for all the partial regions obtained by performing division by the predetermined number of divisions. If the processing has been completed for all the partial regions (Yes), the processing proceeds to step S1009, and if processing has not been completed (No), the processing proceeds to step S1004. In the case of transitioning to step S1004, an unprocessed partial region to be processed next is selected.

In step S1009, the image information determination unit 204 determines whether the number of regions counted in step S1007 is greater than or equal to a predetermined threshold. If it is greater than or equal to the predetermined threshold (Yes), the processing transitions to step S505, and if it is less than the threshold (No), the processing transitions to step S1010.

In step S1010, the image information determination unit 204 assumes, as the determination region, one of the partial regions obtained by dividing the captured image by the predetermined number of divisions and calculates a surface area of a region in which the in-focus degree determination accuracy is high in the determination region. In step S1011, the image information determination unit 204 calculates a “surface area of an in-focus region” in a region for which the surface area has been calculated in step S1010, using the in-focus degree information obtained in step S501.

In step S1012, the image information determination unit 204 determines whether a ratio of the surface areas (number of pixels) calculated in steps S1010 and S1011 (surface area of step S1010 is a denominator and surface area of step S1011 is a numerator) is greater than or equal to a predetermined threshold. Then, if the ratio is greater than or equal to the threshold (Yes), the processing transitions to step S1013, and if the ratio is less than the threshold (No), the processing transitions to step S1014.

In step S1013, the image information determination unit 204 counts the number of regions in which it is determined in step S1012 that the ratio is greater than or equal to the predetermined threshold (Yes) and records the number in the storage unit 207.

In step S1014, the image information determination unit 204 determines whether the processing of steps S1010 to S1012 has been completed for all the partial regions obtained by performing division by the predetermined number of divisions. If the processing has been completed for all the partial regions (Yes), the processing proceeds to step S1015, and if processing has not been completed (No), the processing proceeds to step S1010. In the case of transitioning to step S1010, an unprocessed partial region to be processed next is selected.

In step S1015, the image information determination unit 204 determines whether the number of regions counted in step S1013 is greater than or equal to a predetermined threshold. If it is greater than or equal to the predetermined threshold (Yes), the processing transitions to step S505, and if it is less than the threshold (No), the processing transitions to step S506.

As described above, according to the second embodiment, image quality determination is performed only in a region in which the accuracy of determination (in-focus degree determination) in which in-focus degree information is used is greater than or equal to what is predetermined. This makes it possible to reduce the number of determination regions for which it is determined that the image quality is NG and reduce image recapturing.

In addition, in-focus degree determination is retried while changing the determination region (entire image→each partial region→each region in which the in-focus degree determination accuracy is high in a partial region). This makes it possible to reduce the burden on the user for when in-focus degree determination is NG.

### Third Embodiment

In the first and second embodiments, a form in which image quality determination is performed using in-focus degree information (defocus map) has been described. Meanwhile, as described above, it is also possible to perform image quality determination using a degree of bokeh based on frequency analysis processing. Therefore, in the third embodiment, a form in which, in addition to determination according to in-focus degree information of a captured image, determination in which frequency information of the captured image is used is also performed will be described.

Frequency information is obtained by performing frequency analysis processing on a captured image, and calculating an average value of obtained frequency components. If the calculated average value is small, it indicates that there are few high-frequency components (i.e., portions in which edges are sharp) and a degree of bokeh or blur is high. In addition to bokeh determination in which in-focus degree information is used, blur determination in which frequency analysis is used can be performed.

### <Operation of Apparatus>

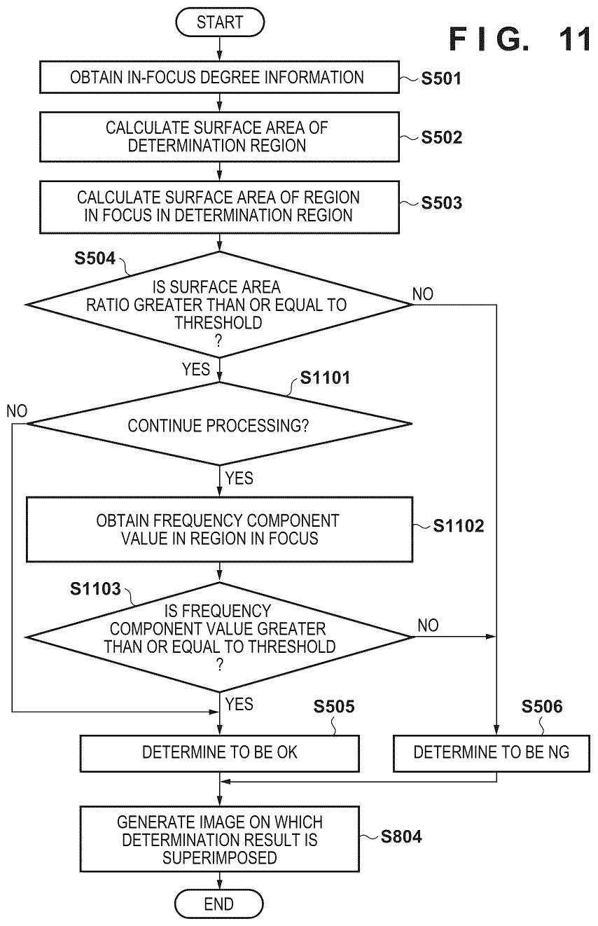

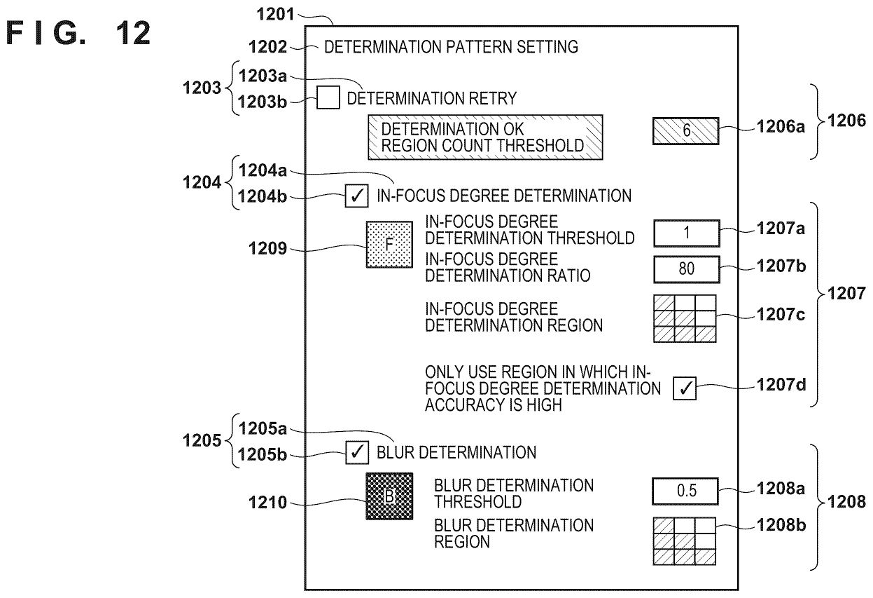

FIG. 11 is a flowchart of the image quality determination processing (step S306) in the third embodiment. A difference from the first embodiment (FIG. 5) is that determination (steps S1101 to S1103) in which frequency information is used is also performed.

In step S1101, the image information determination unit 204 determines whether to perform determination in which frequency information is used for a determination region for which it has been determined in step S504 that the ratio is greater than or equal to the predetermined threshold. In the case of performing determination (Yes), the processing transitions to step S1102, and in the case of not performing determination, the processing transitions to step S505. Whether to perform processing is designated in advance by the user via a setting screen 1201 to be described with reference to FIG. 12.

In step S1102, the image information determination unit 204 performs frequency analysis processing on a determination region (for which it has been determined in step S504 that the ratio is greater than or equal to the predetermined threshold) and obtains a frequency component value. For example, horizontal frequency components and vertical frequency components are calculated using wavelet transform. An average value of obtained frequency components is calculated, and the calculated value is used as the frequency component value.

In step S1103, the image information determination unit 204 determines whether the frequency component value calculated in step S1102 is greater than or equal to a predetermined threshold. If it is greater than or equal to the threshold (Yes), the processing transitions to step S505, and if it is less than the threshold (No), the processing transitions to step S506. That is, if it is greater than or equal to the threshold, it is determined that the determination region of interest is an image in which there is little blurring (image that satisfies a blur condition necessary for it to be used in inspection). Meanwhile, if it is less than the threshold, it is determined that the determination region of interest is an image in which the effect of bokeh or blurring is high.

As described above, by performing blur determination processing using frequency analysis after in-focus degree determination, it is possible to determine the occurrence of bokeh due to blurring and more suitably determine whether a captured image is suitable as an inspection image. A situation in which a camera is mounted on a flying object such as a drone and image capturing is performed can be given as an example in which blurring occurs despite the focus being aligned. In this case, the drone may shake due to the wind or the like at the time of image capturing, and blurring may occur.

### <Setting Screen>

FIG. 12 is a diagram illustrating the setting screen 1201, which is an example of a GUI screen for setting a determination condition. The setting screen 1201 is a setting screen for performing a determination pattern setting 1202. The determination pattern setting 1202 includes three portions: a determination retry setting portion 1203, an in-focus degree determination setting portion 1204, and a blur determination setting portion 1205. Checkboxes 1203b, 1204b, and 1205b and input regions 1206, 1207, and 1208 are arranged in the determination retry setting portion 1203, the in-focus degree determination setting portion 1204, and the blur determination setting portion 1205.

The checkboxes 1203b, 1204b, and 1205b are user interface (UI) components for designating whether to execute determination retry, in-focus degree determination, and blur determination, respectively. The input regions 1206, 1207, and 1208 are UI components for designating determination thresholds and the like for determination retry, in-focus degree determination, and blur determination, respectively.

For example, the setting screen 1201 illustrated in FIG. 12 indicates a state in which determination retry is designated to be OFF, in-focus degree determination is designated to be ON, and blur determination is designated to be ON. Therefore, it indicates that in-focus degree determination retry illustrated in FIGS. 10A and 10B is not implemented, and in-focus degree determination and blur determination illustrated in FIG. 11 are implemented. Therefore, while the input regions 1207 and 1208 are in a state in which input is possible, the input region 1206 is grayed out and is in a state in which input is not possible.

An input region 1207a is an input region for designating the predetermined value (threshold for defocus value) in step S503. An input region 1207b is an input region for designating the threshold for a ratio in step S504. An input region 1207c is a UI component for setting regions for which to calculate surface areas in steps S502 and S503. For example, nine divided regions, each configured as a button, are indicated, and a region for which a push of the button by the user has been accepted is assumed as a determination region.

By designating a region of infrastructure in a captured image in the input region 1207c, determination of image quality of the infrastructure can be performed more appropriately. Further, by reducing a region that is to be a target of determination (decreasing the surface area), the amount of calculation processing is reduced, and improvement in speed is expected.

An input region 1208a is an input region for designating the threshold for a frequency component value in step S1103. An input region 1208b is a UI component for setting a region for which to calculate a frequency component value in step S1102. For example, nine divided regions, each configured as a button, are indicated, and a region for which a push of the button by the user has been accepted is assumed as a determination region.

By designating a region of infrastructure in a captured image in the input region 1208b, a similar effect to the effect of the input region 1207c can be obtained. In addition, when a structure to be inspected is something like a pier, it is possible to obtain an effect of suppressing high-frequency components, which is caused by plants and the like being imaged behind the structure.

As described above, according to the third embodiment, in addition to determination according to in-focus degree information of a captured image, blur determination in which frequency information of the captured image is used is also performed. This makes it possible to more appropriately determine the effect of blurring that may occur in image capturing in which a drone is used. In the above description, blur determination is performed after in-focus degree determination, but these may be performed in reversed order. Further, a configuration may be taken so as to, after performing the two determinations in parallel, integrate the results.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-127327, filed Aug. 3, 2023 which is hereby incorporated by reference herein in its entirety.

What is claimed is:

1. An information processing apparatus comprising:
an image obtaining unit configured to obtain a captured image including a structure to be inspected;
an information obtaining unit configured to obtain in-focus degree information indicating a degree of in-focus of each of a plurality of regions of the captured image;
a selection unit configured to select one or more partial regions from a plurality of partial regions obtained by dividing the captured image into regions; and
a determination unit configured to determine whether the captured image satisfies an in-focus condition necessary for being used in inspection,
wherein the determination unit
identifies, as an in-focus region, a region that is in focus in a first region, in which an accuracy of determination in which the in-focus degree information is used is greater than or equal to what is predetermined, in the selected one or more partial regions, and
determines whether the captured image satisfies the in-focus condition necessary for being used in inspection based on a ratio of a surface area of the first region to a surface area of the in-focus region.

2. The information processing apparatus according to claim 1, wherein
the one or more partial regions are regions in which the structure is captured in the captured image.

3. The information processing apparatus according to claim 1, wherein
the selection unit includes an acceptance unit configured to accept selection of one or more partial regions from a user.

4. The information processing apparatus according to claim 1, wherein
the information obtaining unit further obtains image capturing condition information indicating an image capturing condition for when the captured image has been captured, and
in a case where the image capturing condition does not match a predetermined image capturing condition, the determination unit determines that the captured image cannot be used in inspection.

5. The information processing apparatus according to claim 1, further comprising:
a display control unit configured to display, on a display unit, the captured image and a result of determination by the determination unit for the captured image in association with each other.

6. The information processing apparatus according to claim 5, wherein
the in-focus degree information is a defocus map corresponding to the captured image, and
the display control unit displays a contour diagram of the defocus map in a superimposed manner on the captured image displayed on the display unit.

7. The information processing apparatus according to claim 1, wherein
the information obtaining unit further obtains frequency information indicating a result of analyzing a frequency of the captured image, and
for the captured image determined to satisfy the in-focus condition, the determination unit derives a frequency component corresponding to the one or more partial regions based on the frequency information.

8. The information processing apparatus according to claim 7, wherein
in a case where the frequency component is greater than or equal to a threshold, the determination unit determines that the captured image satisfies a blur condition necessary for being used in inspection.

9. An information processing apparatus comprising:
an image obtaining unit configured to obtain a captured image including a structure to be inspected;
an information obtaining unit configured to obtain frequency information indicating a result of analyzing a frequency of the captured image;
a selection unit configured to select one or more partial regions from a plurality of partial regions obtained by dividing the captured image into regions; and
a determination unit configured to determine whether the captured image satisfies an in-focus condition necessary for being used in inspection based on the frequency information and the selected one or more partial regions.

10. The information processing apparatus according to claim 9, wherein
the determination unit
determines a first region in which bokeh or blurring has not occurred in the selected one or more partial regions based on the frequency information, and
determines whether the captured image satisfies a condition necessary for being used in inspection based on a ratio of a surface area of the first region to a surface area of the one or more partial regions.

11. A method of controlling an information processing apparatus, the method comprising:
obtaining a captured image including a structure to be inspected;
obtaining in-focus degree information indicating a degree of in-focus of each of a plurality of regions of the captured image;
selecting one or more partial regions from a plurality of partial regions obtained by dividing the captured image into regions; and
determining whether the captured image satisfies an in-focus condition necessary for being used in inspection,
wherein in the determining,
a region that is in focus in a first region, in which an accuracy of determination in which the in-focus degree information is used is greater than or equal to what is predetermined, in the selected one or more partial regions is identified as an in-focus region, and
whether the captured image satisfies the in-focus condition necessary for being used in inspection is determined based on a ratio of a surface area of the first region to a surface area of the in-focus region.

12. A method of controlling an information processing apparatus, the method comprising:
obtaining a captured image including a structure to be inspected;
obtaining frequency information indicating a result of analyzing a frequency of the captured image;
selecting one or more partial regions from a plurality of partial regions obtained by dividing the captured image into regions; and
determining whether the captured image satisfies an in-focus condition necessary for being used in inspection based on the frequency information and the selected one or more partial regions.

13. A non-transitory computer-readable recording medium storing a program that, when executed by a computer, causes the computer to perform a method of controlling an information processing apparatus, the method comprising:
obtaining a captured image including a structure to be inspected;
obtaining in-focus degree information indicating a degree of in-focus of each of a plurality of regions of the captured image;
selecting one or more partial regions from a plurality of partial regions obtained by dividing the captured image into regions; and
determining whether the captured image satisfies an in-focus condition necessary for being used in inspection,
wherein in the determining,
a region that is in focus in a first region, in which an accuracy of determination in which the in-focus degree information is used is greater than or equal to what is predetermined, in the selected one or more partial regions is identified as an in-focus region, and
whether the captured image satisfies the in-focus condition necessary for being used in inspection is determined based on a ratio of a surface area of the first region to a surface area of the in-focus region.

14. A non-transitory computer-readable recording medium storing a program that, when executed by a computer, causes the computer to perform a method of controlling an information processing apparatus, the method comprising:
obtaining a captured image including a structure to be inspected;
obtaining frequency information indicating a result of analyzing a frequency of the captured image;
selecting one or more partial regions from a plurality of partial regions obtained by dividing the captured image into regions; and
determining whether the captured image satisfies an in-focus condition necessary for being used in inspection based on the frequency information and the selected one or more partial regions.
